(19) United States
(12) Patent Application Publication
(10) Pub. No.: US 2006/0196320 A1
(43) Pub. Date: Sep. 7, 2006

(54) Adjustable wrench

(76) Inventors: Ching-Fang Hung, Dali City (TW); Hao-Cheng Cheng, Taiping City (TW)

Correspondence Address: DELLETT & WALTERS, P. O. BOX 82788, PORTLAND, OR, 97282-0788, US

(21) Appl. No.: 11/213,226

(22) Filed: Aug. 26, 2005

(30) Foreign Application Priority Data
Mar. 3, 2005 (TW) 094203274

(51) Int. Cl. B25B 13/22

(52) U.S. Cl. 81/133; 81/129.5

(57) ABSTRACT

An adjustable wrench has a body, a movable jaw, a pinion assembly, a sliding rack and a positioning device. The pinion assembly has a first pinion corresponding to and engaging the sliding rack and a second pinion engaging the first pinion and the movable jaw. Thereby, the pinion assembly transversely extends or retracts the movable jaw quickly when the sliding rack is moved longitudinally. Moreover, the positioning device locks the sliding rack in position to keep the movable jaw stable during use.

### BACKGROUND OF THE INVENTION

1. Field of the Invention

The present invention relates to an adjustable wrench, and more particularly to a wrench having an adjustable jaw that can be adjusted rapidly and stably.

2. Description of Related Art

A conventional adjustable wrench in accordance with the prior art comprises a handle, a stationary jaw, an adjustable jaw and a nut. The handle has a distal end and a proximal end. The stationary jaw is formed at the distal end of the handle. The adjustable jaw is L-shaped, is attached movably to the distal end of the handle and has a jaw and a threaded neck. The jaw is aligned with the stationary jaw and separated from the stationary jaw by a variable distance. The threaded neck is mounted transversely in the distal end of the handle. The nut is mounted rotatably inside the handle and screws around the threaded neck of the adjustable jaw. Therefore, the adjustable jaw moves closer to or away from the stationary jaw when the nut is rotated and is held at a desired position to accommodate various sizes of working pieces such as nuts and bolts.

However, the conventional adjustable wrench has the following drawbacks.

1. When the nut rotates once to adjust the adjustable jaw, the adjustable jaw moves only a very short distance in the transverse direction. Therefore, adjustment of the adjustable jaw is time-consuming and inconvenient.

2. Loosely fitting threads are necessary on the threaded neck of the adjustable jaw and the nut to keep the adjustable jaw on the conventional adjustable wrench from binding. Since the conventional adjustable wrench does not have a positioning device, the adjustable jaw easily loosens and cannot clamp the working piece firmly.

To overcome the shortcomings, the present invention provides an adjustable wrench to mitigate or obviate the aforementioned problems.

### SUMMARY OF THE INVENTION

One main objective of the invention is to provide an adjustable wrench that can be adjusted rapidly.

Another main objective of the invention is to provide an adjustable wrench that is reliable and precise.

An adjustable wrench in accordance with the present invention comprises a body, a movable jaw, a pinion assembly, a sliding rack and a positioning device. The pinion assembly has a first pinion corresponding to and engaging the sliding rack and a second pinion engaging the first pinion and the movable jaw. Thereby, the pinion assembly transversely extends or retracts the movable jaw quickly when the sliding rack is moved longitudinally. Moreover, the positioning device locks the sliding rack in position to keep the movable jaw stable during use.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an adjustable wrench in accordance with the present invention;

FIG. 2 is a partially exploded perspective view of the adjustable wrench in FIG. 1;

FIG. 3 is a side view in partial section of the adjustable wrench in FIG. 1;

FIG. 4 is a cross-sectional front view of the adjustable wrench along line 4-4 in FIG. 3;

FIG. 5 is a cross-sectional top view in partial section of the adjustable wrench in FIG. 3;

FIG. 6 is an operational side view of the adjustable wrench in FIG. 3; and

FIG. 7 is an operational cross-sectional top view in partial section of the adjustable wrench in FIG. 5.

### DETAILED DESCRIPTION OF PREFERRED EMBODIMENT

An adjustable wrench in accordance with the present invention comprises a body, a movable jaw, a pinion assembly, a sliding rack and a positioning device. The pinion assembly has a first pinion corresponding to and engaging the sliding rack and a second pinion engaging the first pinion and the movable jaw. Thereby, the pinion assembly transversely extends or retracts the movable jaw quickly when the sliding rack is moved longitudinally. Moreover, the positioning device locks the sliding rack in position to keep the movable jaw stable during use.

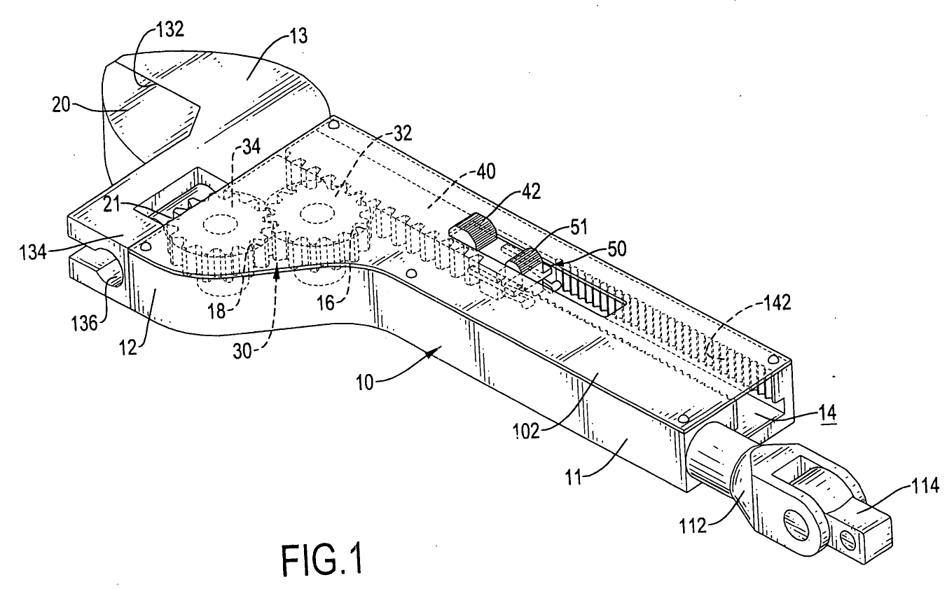

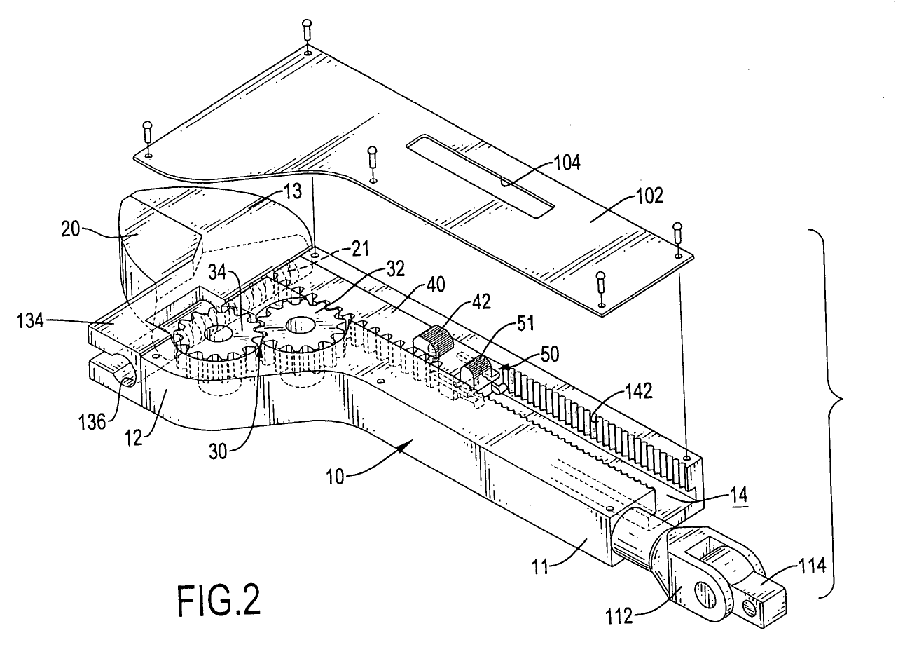

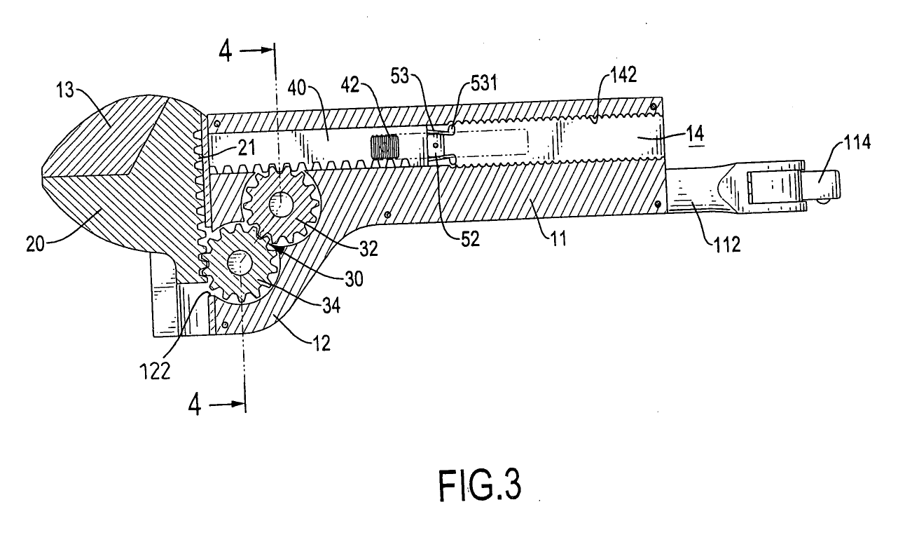

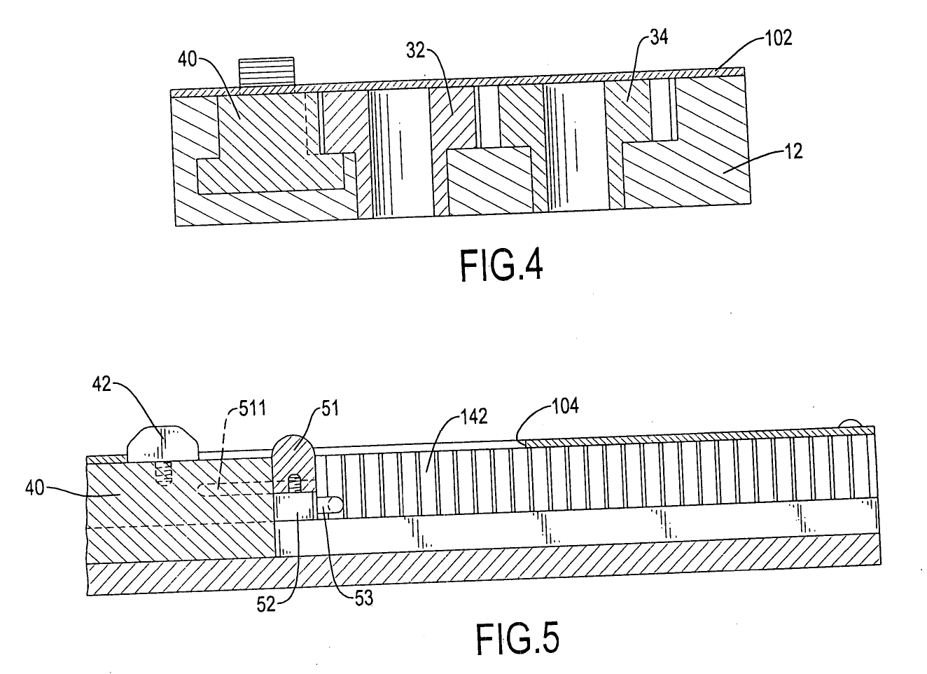

With reference to FIGS. 1 to 4, a preferred embodiment of the adjustable wrench comprises a body (10), a movable jaw (20), a pinion assembly (30), a sliding rack (40) and a positioning device (50).

The body (10) is partially hollow and has an interior cavity, a front end, a rear end, an enlarged head (12), a top, a bottom, a side face, a handle (11), a stationary jaw (13), an optional cover (102) and an optional socket connector (112).

The enlarged head (12) forms the front end of the body (10).

The handle (11) forms the rear end of the body (10).

The interior cavity is defined inside the body (10) and has a front opening (122), a channel (14), a first pinion recess (16) and a second pinion recess (18). The front opening (122) is defined in the front end of the body (10). The channel (14) is longitudinally defined near the top of the body (10), extends to the side face, is preferably an inverted-T shape and has a rear end, a top surface, a bottom surface and multiple detents (142). The detents (142) are formed in line longitudinally in the top and bottom surfaces near the rear end. The first pinion recess (16) is defined in the enlarged front end and communicates with the channel (14). The second pinion recess (18) is defined in the enlarged front end between and communicating with the first pinion recess (16) and the front opening (122).

The stationary jaw (13) is attached to and protrudes longitudinally from the front end of the body (10) and has an upper longitudinal jaw (132) and a hollow transverse neck (134). The upper longitudinal jaw (132) has an abutting face. The hollow transverse neck (134) is formed integrally with and perpendicular to the upper longitudinal jaw (132), firmly attached longitudinally to the front end of the body (10) and has a guide slot (136). The guide slot (136) is defined transversely through stationary jaw (13) and communicates with the front opening (122).

With further reference to FIG. 5, the cover (102) is attached to the side face to close the first and second pinion recesses (16, 18) and has a longitudinal opening (104). The longitudinal opening (104) aligns with the channel (14).

The socket connector (112) is attached to the rear end of the body (10) and has a socket driver (114). The socket driver (114) is attached pivotally to the socket connector (112).

The movable jaw (20) is L-shaped, is movably mounted in the front end of the body (10) and has a toothed transverse neck and a lower longitudinal jaw. The toothed transverse neck is mounted slidably inside the guide slot (136) in the stationary jaw (13) and has an inner edge, an inside end and multiple teeth (21). The inner edge faces the front opening (122) of the body (10). The teeth (21) are formed in the inner edge and align with the front opening (122) so the teeth (21) are exposed to the second pinion recess (18) through the top opening (12). The lower longitudinal jaw is formed at the inside end of the toothed transverse neck, protrudes perpendicularly from the toothed transverse neck outside the guide slot (136) and has an abutting face. The abutting face corresponds to and aligns with the abutting face on the stationary jaw (13) to selectively grip a nut or a head of a bolt.

The pinion assembly (30) is rotatably mounted inside the enlarged head of the body (10) and composed of a first pinion (32) and a second pinion (34). The first pinion (32) is mounted rotatably inside the first pinion recess (16) and extends into the channel (14) and the second pinion recess (18). The second pinion (34) is mounted rotatably inside the second pinion recess (18), engages the first pinion (32) and the teeth (21) on the toothed transverse neck of the movable jaw (20) and selectively moves the movable jaw (20) toward or away 2 from the stationary jaw (13) when the first pinion (32) rotates.

The sliding rack (40) is movably mounted inside the channel (14) 4 perpendicular to the toothed transverse neck of the movable jaw (20) and has a top face, a bottom face, an outer side, an inner side, a rear end, multiple teeth, a push tab (42) and two optional flanges. The teeth are formed on the bottom face, engage the first pinion (32) of the pinion assembly (30) and rotate the first pinion 8 (32) when the sliding rack (40) slides in the channel (14). The push tab (42) is attached to the outer side near the rear end to allow a person to slide the sliding rack (40) easily. The flanges extend respectively from the top and bottom faces 11 on the inner side and correspond to the preferable inverted-T shaped channel (14) 12 to hold the sliding rack (40) in the channel (14).

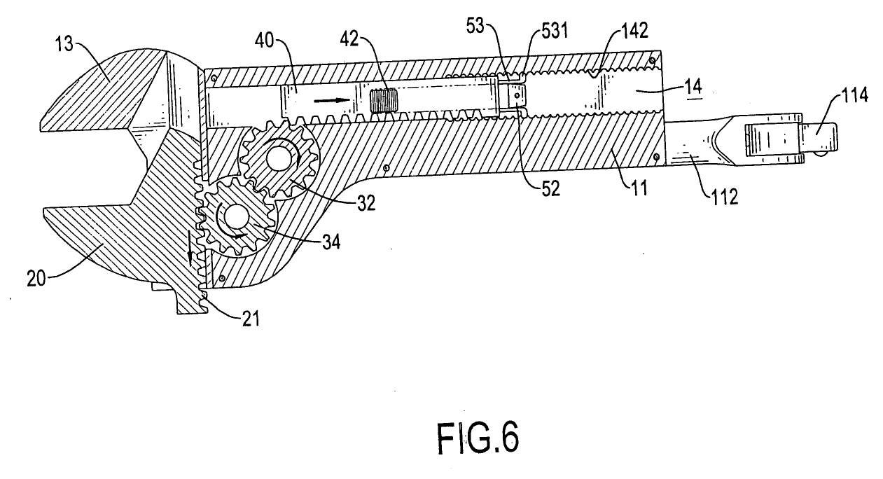

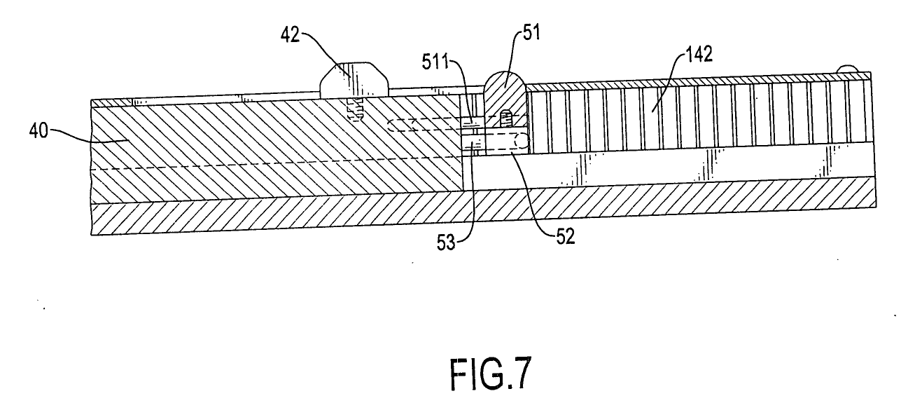

With further reference to FIGS. 6 and 7, the positioning device (50) is attached to the rear end of the sliding rack (40) and comprises a base (51), a screw, a limit (52) and two resilient legs (53). The base (51) has a pin (511) 16 mounted slidably in the rear end of the sliding rack (40). The limit (52) is attached to the base (51) with the screw and has two sides and a tapered distal 18 end. The two resilient legs (53) extend from the rear end of the sliding rack (40) 19 and selectively press respectively against the two sides of the limit (52). Each resilient leg (53) has a distal end and a stub (531). The stubs (531) are formed respectively at the distal ends of the legs (53), protrude outward respectively to abut the top and bottom surfaces of the channel (16) and selectively engage the detents (162). The stubs (531) on the resilient legs (53) are released from the detents (162) when the base (51) is pressed toward the sliding rack (40). When the base (51) is pulled back between the legs (53), the limit (52) presses the legs (53) outward and holds the stubs (531) in the corresponding detents (142), and the sliding rack (40) is locked in position to keep the movable jaw (20) stable.

The adjustable wrench has the following advantages:

1. The sliding rack (40) and the pinion assembly (30) rapidly move the movable jaw (20) with the application of a straight axial force. Therefore, adjustment of the movable jaw (20) is easy and fast.

2. The adjustable wrench of the present invention is stable and reliable in use because the positioning device (50) on the adjustable wrench securely holds the movable jaw (20) in position.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An adjustable wrench comprising:
a body being partially hollow and having
a front end;
a rear end;
a top;
a bottom;
a side face;
an enlarged head forming the front end;
a handle forming the rear end; and
an interior cavity defined inside the body and having
a front opening formed in the front end of the body;
a channel longitudinally defined near the top of the body, extending to the side face and having a rear end, a top surface, and a bottom surface;
a first pinion recess defined in the enlarged front end and communicating with the channel; and
a second pinion defined in the enlarged front end between and communicating with the first pinion recess and the front opening;
a stationary jaw attached to and protruding longitudinally from the front end of the body and having
an upper longitudinal jaw having an abutting face; and
a hollow transverse neck formed integrally with and perpendicular to the upper longitudinal jaw, firmly attached longitudinally to the front end of the body and having a guide slot longitudinally defined through the hollow transverse neck and communicating with the front opening;
a movable jaw being L-shaped, movably mounted in the front end of the body and having
a tooth transverse neck mounted slidably inside the guide slot in the stationary jaw and having
an inside end;
an inner edge facing the front opening of the body; and
multiple teeth formed on the inner edge of the toothed transverse neck and aligning with the front opening; and
a lower longitudinal jaw formed at the inside end of the toothed transverse neck, protruding perpendicular from the toothed transverse neck outside the guide slot and having an abutting face corresponding to and aligning with the abutting face on the upper longitudinal jaw of the stationary jaw; and
a pinion assembly rotatably mounted inside the enlarged head of the body and having
a first pinion mounted rotatably inside the first pinion recess and extending into the channel and the second pinion recess;
a second pinion mounted rotatably inside the second pinion recess and engaging the first pinion and the teeth on the toothed transverse neck of the movable jaw;
a sliding rack movably mounted inside the channel perpendicular to the toothed transverse neck of the adjustable jaw and having
a top face;
a bottom face;
an outer side;
an inner side;
a rear end;
multiple teeth formed on the bottom face, engaging the first pinion and rotating the first pinion when the sliding rack slides in the channel; and
a push tab attached to the outer side near the rear end; and
a positioning device attached to the rear end of the sliding rack.

2. The adjustable wrench as claimed in claim 1, wherein:
the channel further has multiple detents formed in line longitudinally in the top and bottom surfaces near the rear end inside the channel; and
the positioning device has:
a base having a pin mounted slidably in the rear end of the sliding rack;
a screw;
a limit attached to the base with the screw and having
two sides; and
a tapered distal end; and
two resilient legs extending from the rear end of the sliding rack and selectively pressing respectively against the two sides of the limit, and each resilient leg having
a distal end; and
a stub formed at the distal end, protruding outward and selectively engaging the detents.

3. The adjustable wrench as claimed in claim 1, wherein
the channel is an inverted T-shaped channel; and
the sliding rack has two flanges extending respectively from the top face and the bottom face on the inner side of the sliding rack and correspond to the inverted T-shaped channel.

4. The adjustable wrench as claimed in claim 2, wherein
the channel is an inverted T-shaped channel; and
the sliding rack has two flanges extending respectively from the top face and the bottom face on the inner side of the sliding rack and correspond to the inverted T-shaped channel.

5. The adjustable wrench as claimed in claim 1, wherein the body further has a socket connector attached to the rear end of the body and having a rectangular driving block pivotally attached to the socket connector.

6. The adjustable wrench as claimed in claim 2, wherein the body further has a socket connector attached to the rear end of the body and having a rectangular driving block pivotally attached to the socket connector.

7. The adjustable wrench as claimed in claim 1, wherein the body further has a cover attached to the side face to close the first and second pinion recesses, and the cover has a longitudinal opening aligning with the channel.
